(19) United States
(12) Patent Application Publication
(10) Pub. No.: US 2014/0306790 A1
(43) Pub. Date: Oct. 16, 2014

(54) CHOKE COIL AND ELECTRONIC DEVICE

(71) Applicant: HONDA MOTOR CO., LTD., Tokyo (JP)

(72) Inventors: Tsutomu Fukui, Haga-gun (JP); Kazuhiko Yamaguchi, Utsunomiya-shi (JP); Satoshi Ueno, Utsunomiya-shi (JP); Takanori Yamazaki, Utsunomiya-shi (JP)

(73) Assignee: HONDA MOTOR CO., LTD., Tokyo (JP)

(21) Appl. No.: 14/247,413

(22) Filed: Apr. 8, 2014

(30) Foreign Application Priority Data
Apr. 10, 2013 (JP) 2013-082002

(51) Int. Cl. H01F 27/00

(52) U.S. Cl. CPC H01F 27/006
USPC 336/196

(57) ABSTRACT

A choke coil includes a core that is formed to have a ring shape and a winding member that is provided with an electrically conductive wire wound around the core. A housing member, interposed between the core and the winding member, is formed of a material having non-magnetic and non-conductive properties, has a ring shape corresponding to the core, and covers the core. The housing member is formed in such a manner that a separation distance along a radial direction between an outer surface of the housing member and an outer surface of the core becomes uniform over a circumferential direction.

### CROSS-REFERENCE TO RELATED APPLICATION

Priority is claimed on Japanese Patent Application No. 2013-82002, filed on Apr. 10, 2013, the content of which is incorporated herein by reference.

### BACKGROUND

1. Field of the Invention

The present invention relates to a choke coil and an electronic device.

2. Description of Related Art

Hitherto, there is a known signal transmission circuit that reduces common mode noise of two signal lines of an electronic device or the like by a bifilar-wound choke coil in which two electrically conductive wire members are wound around a core member, formed of common ferrite or the like, in the same direction (for example, refer to Japanese Unexamined Patent Application, First Publication No. 2005-354140).

Here, in order to take appropriate measures against noise, it is necessary to secure desired characteristics regarding impedance frequency characteristics of a choke coil (normal mode choke coil and common mode choke coil) by using, for example, an artificial mains network (LISN: line impedance stabilization network). The required desired characteristics include no occurrence of attenuation and resonance in a wide frequency band.

In order to obtain such characteristics, for example, there is a known choke coil in which a coaxial cable is used as an electrically conductive wire member, a corrugated tube formed of, for example, an insulating resin is mounted to an outer circumferential surface of a core member, and the coaxial cable is wound around the core member for each corrugated tube.

### SUMMARY

However, in the related art, there is a concern that a void between a core member and a winding member may not be sufficiently secured due to crushing of a corrugated tube. In addition, there is a concern that electrically conductive wires of the winding member on the outer surface of the corrugated tube may not be located at regular intervals. For this reason, capacitance (parasitic capacitance) between electrically conductive wires of a choke coil becomes large and non-uniform, and thus there is a concern that attenuation and resonance may occur in a specific high frequency region (for example, 100 MHz band or 300 MHz band). That is, in the related art, there is room for improvement in that appropriate desired impedance characteristics be obtained in a wide frequency band.

An aspect according to the invention is contrived in view of the above-described situations, and an object thereof is to provide a choke coil and an electronic device which are capable of securing appropriate desired impedance characteristics in a wide frequency band.

In order to solve the above-described problems, an aspect according to the invention adopts the following means.

(1) A choke coil of an aspect according to the invention is a choke coil including a core that is formed to have a ring shape, and a winding member that is provided with an electrically conductive wire wound around the core. A housing member, interposed between the core and the winding member, is formed of a material having non-magnetic and non-conductive properties, has a ring shape corresponding to the core, and covers the core. The housing member is formed in such a manner that a separation distance along a radial direction between an outer surface of the housing member and an outer surface of the core becomes uniform over a circumferential direction.

According to an aspect of (1) mentioned above, since the housing member is formed in such a manner that the separation distance along the radial direction between the outer surface of the housing member and the outer surface of the core becomes uniform over the circumferential direction, it is possible to sufficiently secure the separation distance between the electrically conductive wire and the outer surface of the core when forming the winding member by winding the electrically conductive wire around the core through the housing member and to make the separation distance become uniform over the circumferential direction. Thus, since capacitance between the electrically conductive wires of the choke coil can be made small and uniform, it is possible to secure appropriate desired impedance characteristics in a wide frequency band.

(2) In the aspect of (1) mentioned above, a plurality of guide units are formed on the outer surface of the housing member. The guide units may regulate the electrically conductive wire so that when the electrically conductive wire of the winding member is wound, the positions of the electrically conductive wires are located at regular intervals over the circumferential direction thereof.

In the case of (2) mentioned above, on the outer surface of the housing member, the plurality of guide units regulating the electrically conductive wire so that when the electrically conductive wire of the winding member is wound, the positions of the electrically conductive wires are located at regular intervals over the circumferential direction thereof are formed, and thus capacitance between the electrically conductive wires can become further uniform. In addition, in a winding process of the electrically conductive wire during the manufacture of the choke coil, it is possible to easily wind the electrically conductive wire so that the positions of the electrically conductive wires are located at regular intervals on the outer surface of the housing member. Therefore, it is possible to manufacture the choke coil having small and uniform capacitance between the electrically conductive wires with satisfactory work efficiency and to secure appropriate desired impedance characteristics in a wide frequency band.

(3) In the aspect of (1) or (2) mentioned above, a spacer member may be provided coaxially with a central axis of the core within a center hole of the core. A plurality of groove portions extending along the axial direction and capable of disposing the electrically conductive wire may be formed in an outer circumferential surface of the spacer member in response to the number of times of insertion of the electrically conductive wire into the center hole of the core. The plurality of the groove portions may be formed at regular intervals over the circumferential direction.

In the case of (3) mentioned above, the spacer member is provided within the center hole of the core, and the plurality of groove portions capable of disposing the electrically conductive wire is formed in the outer circumferential surface of the spacer member in response to the number of times of insertion of the electrically conductive wire, and thus all the electrically conductive wires inserted into the center hole of the core can be disposed within the groove portions of the spacer member. Moreover, since the plurality of groove portions is formed at regular intervals over the circumferential direction, it is possible to easily wind the electrically conductive wires so that the positions of the electrically conductive wires inserted into the center hole of the core are located at regular intervals in a winding process of the electrically conductive wire during the manufacture of the choke coil. Therefore, it is possible to manufacture the choke coil having small and uniform capacitance between the electrically conductive wires with satisfactory work efficiency and to secure appropriate desired impedance characteristics in a wide frequency band.

(4) In any one aspect of (1) to (3) mentioned above, the housing member may include a supporting portion that extends toward the outside in the radial direction. A base portion protruding so as to intersect an extension direction of the supporting portion may be formed in a tip of the supporting portion.

In the case of (4) mentioned above, since the base portion protruding so as to intersect the extension direction of the supporting portion is formed in a tip of the supporting portion of the housing member, the base portion is brought into surface contact with a principal plane of the substrate when mounting the choke coil to, for example, the substrate of the electronic device and is fixed using, for example, a screw or an adhesive, and thus it is possible to mount the choke coil to the substrate while securing satisfactory work efficiency. In addition, since the choke coil can be mounted to the substrate by bringing the base portion into surface contact with the principal plane of the substrate, it is possible to mount the choke coil to the substrate while securing stability. Therefore, it is possible to improve durability of the electronic device or the like on which the choke coil according to the invention is mounted.

(5) In any one aspect of (1) to (4) mentioned above, the core may be formed in such a manner that a plurality of core members having different impedance frequency characteristics are laminated in the axial direction.

In the case of (5) mentioned above, it is possible to appropriately attenuate common mode noise and normal mode noise with respect to a wide frequency band.

In addition, since the electrically conductive wire can be wound around the plurality of core members by simply winding the electrically conductive wire around the housing member, a winding process of the electrically conductive wire can be simplified.

(6) An electronic device of an aspect according to the invention includes the choke coil according to the aspect of (1) mentioned above to attenuate at least one noise of common mode noise and normal mode noise.

According to the aspect of (6) mentioned above, it is possible to appropriately attenuate common mode noise or normal mode noise of the electronic device.

According to an aspect of the invention, since the housing member is formed in such a manner that the separation distance along the radial direction between the outer surface of the housing member and the outer surface of the core becomes uniform over the circumferential direction, it is possible to sufficiently secure the separation distance between the electrically conductive wire and the outer surface of the core when forming the winding member by winding the electrically conductive wire around the core through the housing member and to make the separation distance become uniform over the circumferential direction. Thus, since capacitance between the electrically conductive wires of the choke coil can be made small and uniform, it is possible to secure appropriate desired impedance characteristics in a wide frequency band.

### BRIEF DESCRIPTION OF THE DRAWINGS

FIG. 1 is an explanatory diagram when a choke coil according to an embodiment is viewed from an axial direction.

FIG. 2 is an explanatory diagram when a choke coil according to an embodiment is viewed from a radial direction.

FIG. 3 is an explanatory diagram when a first core member is accommodated in a first housing member.

FIG. 4 is a configuration diagram of an electronic device according to an embodiment.

### DESCRIPTION OF EMBODIMENTS

Now, a choke coil and an electronic device according to an embodiment of the invention will be described with reference to the accompanying drawings. Hereinafter, the choke coil according to the embodiment will be described, and then the electronic device including the choke coil according to the embodiment will be described.

### (Choke Coil)

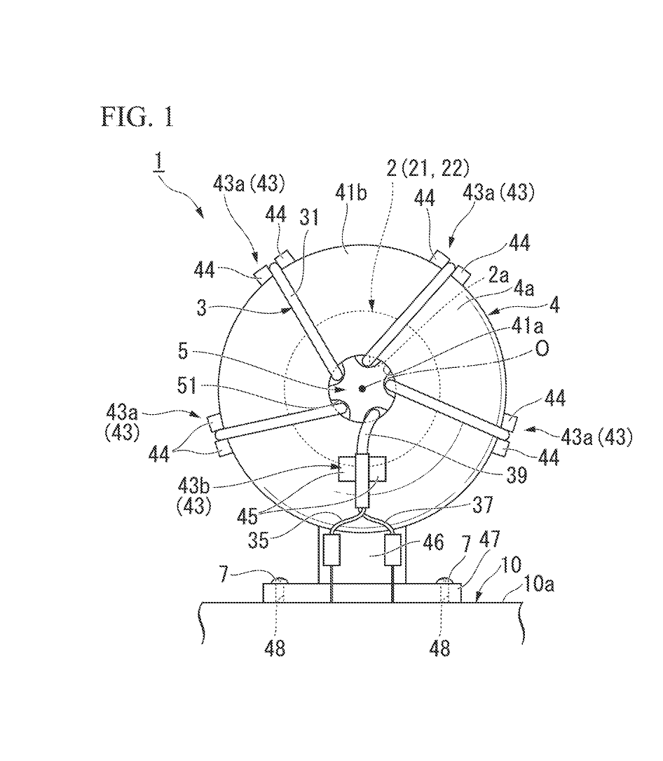

FIG. 1 is an explanatory diagram when a choke coil 1 according to an embodiment is viewed from an axial direction.

As illustrated in FIG. 1, the choke coil 1 includes a core 2 which is formed to have a ring shape, a winding member 3 which is formed by winding an electrically conductive wire 31 around the core 2, a housing member 4 which is interposed between the core 2 and the winding member 3, and a spacer member 5 which is provided within a center hole 2a of the core 2. Now, components of the choke coil 1 will be described in detail. Hereinafter, a direction along a central axis O of the core 2 will be referred to as an axial direction, a direction perpendicular to the central axis O will be referred to as a radial direction, and a direction rotating around the central axis O will be referred to as a circumferential direction.

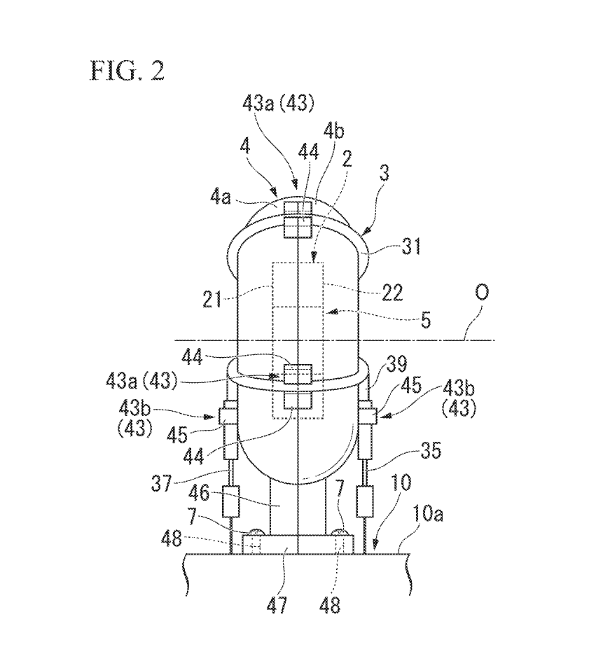

FIG. 2 is an explanatory diagram when the choke coil 1 according to the embodiment is viewed from a radial direction.

As illustrated in FIG. 2, the core 2 includes, for example, a first core member 21 for a low frequency and a second core member 22 for a high frequency. The first core member 21 is formed of, for example, a Mn—Zn-based ferrite material. The second core member 22 is formed of, for example, a Ni—Zn-based ferrite material. The first core member 21 and the second core member 22 have the same ring shape and are covered by the housing member 4 in a state where the first core member and the second core member are disposed concentrically and are laminated in the axial direction.

As illustrated in FIG. 1, the winding member 3 is formed in such a manner that the electrically conductive wire 31 is wound around the core 2 through the housing member 4 by a predetermined number of turns (in this embodiment, four turns) so as to have a spiral shape advancing in the circumferential direction.

The electrically conductive wire 31 forming the winding member 3 is, for example, a coaxial cable, and includes a lead wire 35 which is constituted by a core wire formed of a conductive material and an insulating layer covering the core wire, a shield braided wire 37 which is formed of a conductive material and covers the lead wire 35, and a protective cover 39 which is formed of an insulating material and covers the lead wire 35 and the shield braided wire 37. The electrically conductive wire 31 uses the lead wire 35 and the shield braided wire 37 as two single-phase signal lines. Thus, the lead wire 35 and the shield braided wire 37 constitute two signal lines that are wound on the first core member 21 and the second core member 22 by bifilar-winding.

For example, the lead wire 35 and the shield braided wire 37 are connected to two signal lines routed on a substrate 10a of the electronic device 10 and are connected to a termination resistor (not shown), having a predetermined termination resistance value that is the same as characteristic impedance of the winding member 3, to be terminated. In addition, for example, the electronic device 10 is a measuring instrument such as a vector signal analyzer, a spectrum analyzer, or an oscilloscope, insofar as it is used to measure impedance.

The housing member 4 is formed of, for example, a polyimide-based resin material having non-magnetic and non-conductive properties, and covers a surface other than an inner circumferential surface of the center hole 2a in the outer surface of the core 2. The housing member 4 is constituted by a main body portion 41 which is formed to have a ring shape corresponding to the core 2 and a supporting portion 46 which extends from the main body portion 41 toward the outside in the radial direction.

The central axis of the main body portion 41 is coincident with the central axis O of the core 2. In addition, the diameter of a through hole 41a of the main body portion 41 is equal to the diameter of the center hole 2a of the core 2. An outer surface 41b of the main body portion 41 is a torus surface. The main body portion 41 is configured to be hollow and accommodates the core 2 therein.

The supporting portion 46 is formed to have, for example, a rectangular column shape. The supporting portion is an outer portion in the radial direction in the outer surface 41b of the main body portion 41 and extends along the radial direction from a middle portion in the axial direction toward the outside in the radial direction.

A base portion 47 is formed in a tip of the supporting portion 46. The base portion 47 is formed to have a flat rectangular plate shape and protrudes outwards so as to be perpendicular to the extension direction of the supporting portion 46. A fixed hole 48 passing through the base portion 47 in the thickness direction of the base portion is formed in the vicinity of a corner portion of the base portion 47. For example, a tapping screw 7 is inserted into the fixed hole 48 of the base portion 47 to be threadedly engaged with the substrate 10a of the electronic device 10. Thus, the choke coil 1 is fixed onto the substrate 10a of the electronic device 10.

As illustrated in FIG. 2, the housing member 4 of this embodiment is divided into two parts in the axial direction by a first housing member 4a and a second housing member 4b. Here, the first housing member 4a and the second housing member 4b are formed to have the same shape, and are disposed to be plane-symmetrical about a boundary surface between the first housing member 4a and the second housing member 4b. Therefore, hereinafter, only the first housing member 4a will be described, and the second housing member 4b will not be described.

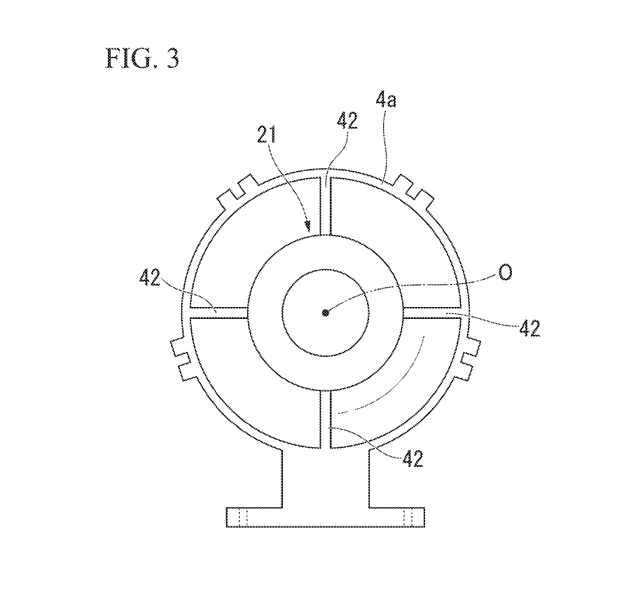

FIG. 3 is an explanatory diagram when the first core member 21 is accommodated in the first housing member 4a.

As illustrated in FIG. 3, a plurality of ribs 42 that have a plate shape protruding inward in a radial direction are formed along the radial direction in the internal surface of the first housing member 4a. In this embodiment, four ribs 42 are formed at intervals of 90 degrees. The lengths of the ribs 42 protruding inward in the radial direction are equal to each other. In addition, a separation distance between inner ends of the ribs 42 facing each other in the radial direction is slightly shorter than an external diameter of the first core member 21. Thus, the first core member 21 is lightly press-fitted into the inner ends of the plurality of ribs 42 to be accommodated in and held by the first housing member 4a. In addition, at this time, since the lengths of the ribs 42 protruding inward in the radial direction are equal to each other, a separation distance along the radial direction between the outer surface of the first housing member 4a and the outer circumferential surface (outer surface) of the first core member 21 becomes uniform over the circumferential direction.

As illustrated in FIG. 2, in a state where the first core member 21 is accommodated in the first housing member 4a and the second core member 22 is accommodated in the second housing member 4b, the first housing member 4a and the second housing member 4b are superimposed on each other to form the housing member 4, and thus the first core member 21 and the second core member 22 are laminated in the axial direction. The core 2 is formed in which the first core member 21 and the second core member 22 having different impedance frequency characteristics are laminated in the axial direction and is accommodated in the housing member 4.

As illustrated in FIG. 1, a plurality of guide units 43 are formed on the outer surface 41b of the main body portion 41 of the housing member 4. The plurality of guide units 43 are disposed around the central axis O at a certain angular interval when viewed from the axial direction. In this embodiment, the guide units 43 are provided in five places when viewed from the axial direction and are disposed around the central axis O at intervals of 72 degrees.

The plurality of guide units 43 are constituted by first guide units 43a provided on an outer surface in the radial direction in the outer surface 41b of the main body portion 41 and provided in a region other than a position corresponding to the supporting portion 46, and second guide units 43b provided on the outer surface in the axial direction in the outer surface 41b of the main body portion 41 and provided at the position corresponding to the supporting portion 46.

The first guide unit 43a is constituted by a pair of guide ribs 44 and 44 which stand toward the outside in the radial direction and extend along the axial direction. For example, the height of each of the pair of guide ribs 44 and 44 is slightly higher than the diameter of the electrically conductive wire 31. In addition, a separation distance between the pair of guide ribs 44 and 44 is slightly longer than the diameter of the electrically conductive wire 31. The electrically conductive wire 31 is disposed between the pair of guide ribs 44 and 44. Thus, the first guide unit 43a disposes the electrically conductive wire 31 at regular intervals over the circumferential direction on the outer surface of the main body portion 41 in the radial direction and regulates the movement of the electrically conductive wire 31 in the circumferential direction.

The second guide unit 43b is constituted by a pair of guide ribs 45 and 45 which stand toward the outside in the axial direction and extend along the radial direction. In addition, the second guide unit 43b is provided on both outer surfaces in the axial direction in the outer surface 41b of the main body portion 41 (see FIG. 2).

For example, the height of each of the pair of guide ribs 45 and 45 is slightly higher than the diameter of the electrically conductive wire 31. In addition, a separation distance between the pair of guide ribs 45 and 45 is slightly longer than the diameter of the electrically conductive wire 31. The electrically conductive wire 31 is disposed between the pair of guide ribs 45 and 45. Thus, one second guide unit 43b regulates the movement of a winding-start end of the electrically conductive wire 31 in the circumferential direction on the outer surface of the main body portion 41 in the axial direction, and suppresses the displacement of the electrically conductive wire 31 in the vicinity of the supporting portion 46. In addition, the other second guide unit 43b suppresses the movement of a winding-finish end of the electrically conductive wire 31 in the circumferential direction on the outer surface of the main body portion 41 in the axial direction, and regulates the displacement of the electrically conductive wire 31 in the vicinity of the supporting portion 46.

The spacer member 5 has a pillar shape, and thus an external size of the spacer member viewed from the axial direction is equal to the inner diameter of the center hole 2a of the core 2. The spacer member 5 is provided coaxially with the central axis of the core 2 and is inserted into the center hole 2a of the core 2.

A plurality of groove portions 51 extending along the axial direction are formed in the outer circumferential surface of the spacer member 5. The depth of the groove portions 51 is equal to, for example, the diameter of the electrically conductive wire 31 so that the electrically conductive wire 31 can be disposed within the groove portions 51.

The plurality of groove portions 51 are formed at regular intervals over the circumferential direction in response to the number of times of insertion of the electrically conductive wire 31 into the center hole 2a of the core 2. In this embodiment, the electrically conductive wire 31 is inserted into the center hole 2a of the core 2 four times in response to the number of winding turns (four turns), and then the winding-finish end of the electrically conductive wire is inserted into the center hole 2a of the core 2 and protrudes, and thus the total number of times of insertion of the electrically conductive wire 31 into the center hole 2a of the core 2 is five times. Therefore, five groove portions 51 are formed in the outer circumferential surface of the spacer member 5. The electrically conductive wire 31 is disposed within the groove portions 51, and thus the spacer member 5 disposes the electrically conductive wires 31 in the circumferential direction at regular intervals within the center hole 2a of the core 2, and regulates the movement of the electrically conductive wire 31 over the circumferential direction.

According to this embodiment, since the housing member 4 is formed in such a manner that a separation distance along the radial direction between the outer surface 41b of the main body portion 41 of the housing member 4 and the outer surface of the core 2 becomes uniform over the circumferential direction, the separation distance between the electrically conductive wire 31 and the outer surface of the core 2 can be sufficiently secured and become uniform over the circumferential direction when winding the electrically conductive wire 31 around the core 2 through the housing member 4 to form the winding member 3. Thus, since capacitance between the electrically conductive wires 31 of the choke coil 1 can be made small and uniform, it is possible to secure appropriate desired impedance characteristics in a wide frequency band.

In addition, the outer surface 41b of the main body portion 41 of the housing member 4 is provided with the plurality of first guide units 43a and the second guide units 43b which regulate the electrically conductive wire 31 so that when the electrically conductive wire 31 of the winding member 3 is wound, the positions of the electrically conductive wires 31 are located at regular intervals over the circumferential direction thereof, and thus capacitance between the electrically conductive wires 31 can become further uniform. In addition, in a winding process of the electrically conductive wire 31 during the manufacture of the choke coil 1, it is possible to easily wind the electrically conductive wire 31 so that the positions of the electrically conductive wires 31 are located at regular intervals on the outer surface 41b of the main body portion 41 of the housing member 4. Therefore, it is possible to manufacture the choke coil 1 having small and uniform capacitance between the electrically conductive wires 31 with satisfactory work efficiency and to secure appropriate desired impedance characteristics in a wide frequency band.

In addition, the spacer member 5 is provided within the center hole 2a of the core 2, and the plurality of groove portions 51 capable of disposing the electrically conductive wire 31 are formed in the outer circumferential surface of the spacer member 5 in response to the number of times of insertion of the electrically conductive wire 31, and thus all the electrically conductive wires 31 inserted into the center hole 2a of the core 2 can be disposed within the groove portions 51 of the spacer member 5. Moreover, since the plurality of groove portions 51 are formed at regular intervals over the circumferential direction, it is possible to easily wind the electrically conductive wires 31 so that the positions of the electrically conductive wires 31 inserted into the center hole 2a of the core 2 are located at regular intervals in a winding process of the electrically conductive wire 31 during the manufacture of the choke coil. Therefore, it is possible to manufacture the choke coil having small and uniform capacitance between the electrically conductive wires 31 with satisfactory work efficiency and to secure appropriate desired impedance characteristics in a wide frequency band.

In addition, since the base portion 47 protruding so as to intersect the extension direction of the supporting portion 46 is formed in a tip of the supporting portion 46 of the housing member 4, the base portion 47 is brought into surface contact with a principal plane of the substrate 10a when mounting the choke coil 1 to, for example, the substrate 10a of the electronic device 10 and is fixed using, for example, a screw or an adhesive, and thus it is possible to mount the choke coil 1 to the substrate 10a while securing satisfactory work efficiency. In addition, since the choke coil 1 can be mounted to the substrate by bringing the base portion 47 into surface contact with the principal plane of the substrate 10a, it is possible to mount the choke coil 1 to the substrate 10a while securing stability. Therefore, it is possible to improve the durability of the electronic device 10 on which the choke coil 1 according to this embodiment is mounted.

In addition, since the core 2 is formed in such a manner that the first core member 21 and the second core member 22 having different impedance frequency characteristics are laminated in the axial direction, it is possible to appropriately attenuate common mode noise and normal mode noise with respect to a wide frequency band.

In addition, since the electrically conductive wire 31 can be wound around the first core member 21 and the second core member 22 by simply winding the electrically conductive wire 31 around the housing member 4, a winding process of the electrically conductive wire 31 can be simplified.

(Electronic Device)

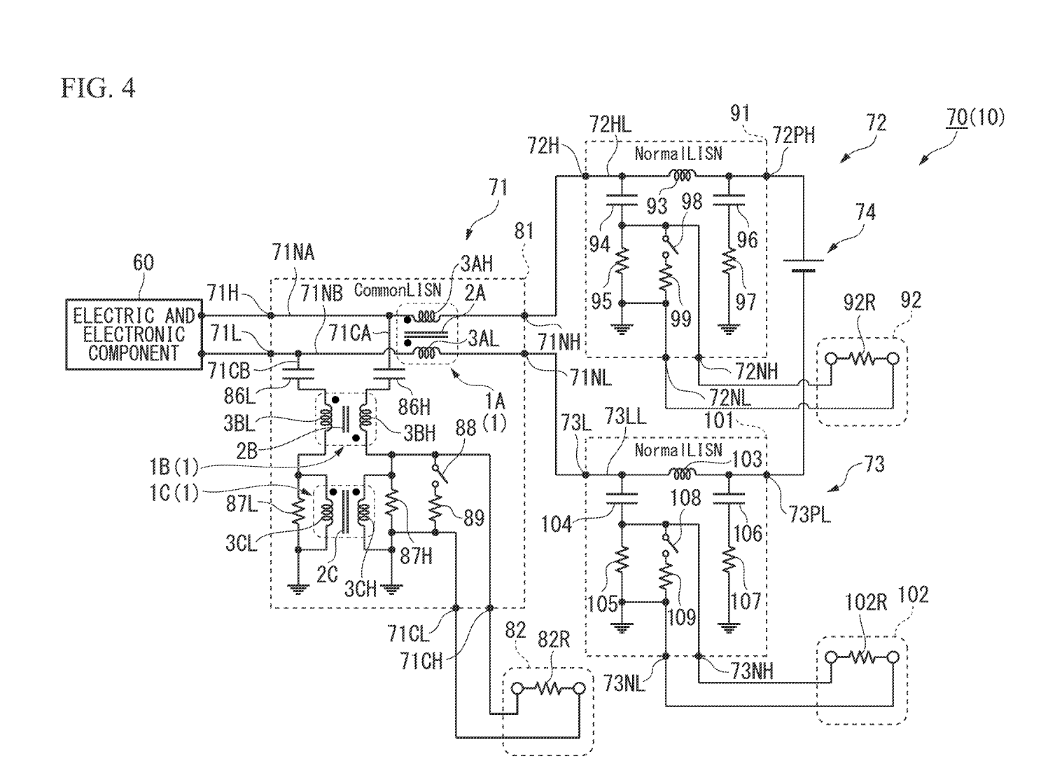

FIG. 4 is a configuration diagram of the electronic device 10 according to an embodiment.

Subsequently, the electronic device 10 including the choke coil 1 according to this embodiment will be described.

The choke coil 1 according to this embodiment is included in an electromagnetic interference wave measuring device 70 (electronic device), as the electronic device 10, for measuring a conductive interference wave (conductive emission) which propagates through a connection line, in an electromagnetic interference (EMI) wave generated from an electric and electronic component 60 which is mounted to, for example, a vehicle. For example, first to third common mode choke coils 1A to 1C to be described later are the choke coil 1 according to the above-described embodiment, of which the frequency characteristics are appropriately adjusted.

As illustrated in FIG. 4, the electromagnetic interference wave measuring device 70 includes a common mode noise detection unit 71, a first normal mode noise detection unit 72, a second normal mode noise detection unit 73, and a power supply 74.

The common mode noise detection unit 71 includes, for example, a noise separation unit 81 and an electronic measuring instrument 82.

A noise separation unit (Common LISN) 81 includes, for example, a line impedance stabilization network (LISN), and separates noise generated in an input terminal on the high side 71H and an input terminal on the low side 71L which are connected to the electric and electronic component 60 into common mode noise and normal mode noise. The separated common mode noise is output to a common mode output terminal on the high side 71CH and a common mode output terminal on the low side 71CL, and the separated normal mode noise is output to a normal mode output terminal on the high side 71NH and a normal mode output terminal on the low side 71NL.

The noise separation unit 81 includes, for example, the first, second, and third common mode choke coils 1A, 1B, and 1C, a pair of capacitors 86H and 86L, a pair of resistors 87H and 87L, a termination resistor changeover switch 88, and a changeover termination resistor 89.

The first common mode choke coil 1A (choke coil) includes, for example, a pair of windings 3AH and 3AL and a core 2A.

For example, the pair of windings 3AH and 3AL electromagnetically coupled to each other through the core 2A are wound in such a manner that inductance for the common mode noise becomes larger than inductance for the normal mode noise without attenuating inductance for the normal mode noise.

The winding 3AH is inserted into a normal mode connection line 71NA that connects the input terminal on the high side 71H and the normal mode output terminal on the high side 71NH, and the winding 3AL is inserted into a normal mode connection line 71NB that connects the input terminal on the low side 71L and the normal mode output terminal on the low side 71NL.

For example, the first common mode choke coil 1A generates mutual inductance between the normal mode connection lines 71NA and 71NB to attenuate the common mode noise and to pass the normal mode noise without attenuating the normal mode noise.

The windings 3AH and 3AL are constituted by, for example, a coaxial cable, and suppress the attenuation of the normal mode noise while securing the amount of attenuation of the common mode noise. Further, for example, the windings 3AH and 3AL can further suppress the attenuation of the normal mode noise by performing impedance matching between terminals of the coaxial cables.

The second common mode choke coil 1B (choke coil) includes, for example, a pair of windings 3BH and 3BL and a core 2B.

For example, the pair of windings 3BH and 3BL electromagnetically coupled to each other through the core 2B are wound in such a manner that inductance for the normal mode noise becomes larger than inductance for the common mode noise without attenuating inductance for the common mode noise.

The third common mode choke coil 1C (choke coil) includes, for example, a pair of windings 3CH and 3CL and a core 2C.

For example, the pair of windings 3CH and 3CL electromagnetically coupled to each other through the core 2C are wound in such a manner that inductance for the common mode noise becomes larger than inductance for the normal mode noise without attenuating inductance for the normal mode noise.

The windings 3CH and 3CL are constituted by, for example, a coaxial cable, and suppress the attenuation of the normal mode noise while securing the amount of attenuation of the common mode noise. Further, for example, the windings 3CH and 3CL can further suppress the attenuation of the normal mode noise by performing impedance matching between terminals of the coaxial cables.

For example, the capacitor 86H, the winding 3BH, and the winding 3CH are sequentially connected to each other in series, and are inserted into a common mode connection line 71CA that connects the input terminal on the high side 71H and a grounding point. For example, the capacitor 86L, the winding 3BL, and the winding 3CL are sequentially connected to each other in series, and are inserted into a common mode connection line 71CB that connects the input terminal on the low side 71L and a grounding point.

For example, the pair of windings 3BH and 3BL of the second common mode choke coil 1B are wound so that a reversed-phase voltage is generated, and are inserted into the common mode connection lines 71CA and 71CB, respectively.

For example, the second common mode choke coil 1B generates mutual inductance between the common mode connection lines 71CA and 71CB to attenuate the normal mode noise and to pass the common mode noise without attenuating the common mode noise.

Both ends of the winding 3CH of the third common mode choke coil 1C are connected to the common mode output terminal on the high side 71CH and the common mode output terminal on the low side 71CL, respectively.

The resistor 87H is connected, for example, between both ends of the winding 3CH of the third common mode choke coil 1C, and the resistor 87L is connected, for example, between both ends of the winding 3CL of the third common mode choke coil 1C.

For example, the third common mode choke coil 1C generates mutual inductance between the common mode connection lines 71CA and 71CB to pass (ground and short circuit) the normal mode noise to the grounding point.

The third common mode choke coil 1C and the pair of resistors 87H and 87L induce a voltage between both ends of the resistor 87L due to the common mode noise between the common mode output terminal on the high side 71CH and the common mode output terminal on the low side 71CL, for example, by a transformer function.

For example, the termination resistor changeover switch 88 and the changeover termination resistor 89 are connected in series between the common mode output terminal on the high side 71CH and the common mode output terminal on the low side 71CL.

The electronic measuring instrument 82 includes a measuring instrument such as a vector signal analyzer, a spectrum analyzer, or an oscilloscope which digitizes the size (level or the like) of noise inclusive of a time variation to measure a voltage or the like of noise (for example, common mode noise) which is output from the common mode output terminal on the high side 71CH and the common mode output terminal on the low side 71CL.

For example, the electronic measuring instrument 82 includes a termination resistor 82R that connects the common mode output terminal on the high side 71CH and the common mode output terminal on the low side 71CL.

For example, in an opened state of the termination resistor changeover switch 88, the electronic measuring instrument 82 measures common mode noise using a first termination resistance value (for example, 50Ω) based on a resistance value (for example, 50Ω) of the termination resistor 82R. On the other hand, in a closed state of the termination resistor changeover switch 88, the electronic measuring instrument measures common mode noise using a second termination resistance value (for example, 25Ω) based on a combination of a resistance value (for example, 50Ω that is the same as the resistance value of the termination resistor 82R) of the changeover termination resistor 89 and the resistance value (for example, 50Ω) of the termination resistor 82R.

For example, the electronic measuring instrument 82 estimates internal impedance of common mode noise in the single electric and electronic component 60 on the basis of changes in measurement results according to a change in a termination resistance value which is associated with switching between opening and closing of the termination resistor changeover switch 88.

An output voltage of the common mode noise in the single electric and electronic component 60 is estimated on the basis of the estimation results of the internal impedance.

For example, the measurement results of a voltage of common mode noise in the first termination resistance value (for example, 50Ω) and the second termination resistance value (for example, 25Ω) with respect to common mode noise of an appropriate output voltage V(x) having appropriate internal impedance Im(x) in the single electric and electronic component 60 change to V(50Ω) and V(25Ω), for example, as expressed by the following Expression (1).

That is, when the termination resistance value changes to the first termination resistance value (for example, 50Ω) and the second termination resistance value (for example, 25Ω) by switching between opening and closing of the termination resistor changeover switch 88, a division ratio between the internal impedance Im(x) and the termination resistance value changes. The measurement results of the voltage of the common mode noise change to V(50Ω) and V(25Ω) in response to the change in the division ratio.

$$\begin{matrix}V ( 50 Ω ) = \frac{50}{50 + Im ( x )} \times V ( x ) \\ V ( 25 Ω ) = \frac{25}{25 + Im ( x )} \times V ( x )\end{matrix} \} \qquad ( 1 )$$

For example, the electronic measuring instrument 82 estimates the internal impedance Im(25 Ω→50Ω) of the common mode noise in the single electric and electronic component 60, for example, as expressed by the following Expression (2), on the basis of the amount of change ΔV according to the measurement results of the voltage of the common mode noise changing to V(50Ω) and V(25Ω).

$$Im ( 25 Ω \to 50 Ω ) = 50 \times \frac{( 1 - {10}^{( \frac{Δ V}{20} )} )}{( 2 \times {10}^{( \frac{Δ V}{20} )} - 1 )} \qquad ( 2 )$$

In addition, optimal values of the first termination resistance value and the second termination resistance value that change by switching between opening and closing of the termination resistor changeover switch 88 may change in accordance with the internal impedance Im(x) or the like.

In order to suppress the reflection of an electromagnetic interference wave between the electromagnetic interference wave measuring device 70 and the electric and electronic component 60, a distance of connection between the electromagnetic interference wave measuring device 70 and the electric and electronic component 60 through a harness may be set to equal to or less than a predetermined distance (for example, λ/10 or λ/20 based on a wavelength λ of the electromagnetic interference wave).

For example, as expressed by the following Expression (3), the electronic measuring instrument 82 estimates an output voltage P(50Ω) of common mode noise on the basis of internal impedance Im(25 Ω→50Ω) of the common mode noise and a measurement result of a voltage (for example, V(50Ω)) of the common mode noise in the first termination resistance value (for example, 50Ω).

$$P ( 50 Ω ) = 20 \times {log}_{10} ( \frac{Im ( 25 Ω \to 50 Ω ) + 50}{50} ) + V ( 50 Ω ) \qquad ( 3 )$$

The first normal mode noise detection unit 72 includes, for example, an artificial mains network 91 and an electronic measuring instrument 92.

The artificial mains network (Normal LISN) 91 includes, for example, a line impedance stabilization network (LISN), and includes a normal mode input terminal on the high side 72H connected to the normal mode output terminal on the high side 71NH of the common mode noise detection unit 71, a power supply terminal on the high side 72PH connected to a positive electrode of the power supply 74, a first normal mode output terminal on the high side 72NH, and a first normal mode output terminal on the low side 72NL.

The artificial mains network 91 includes, for example, a winding 93, a first capacitor 94, a first resistor 95, a second capacitor 96, a second resistor 97, a termination resistor changeover switch 98, and a changeover termination resistor 99.

For example, the winding 93 is inserted into a connection line 72HL that connects the normal mode input terminal on the high side 72H and the power supply terminal on the high side 72PH.

For example, the normal mode input terminal on the high side 72H is connected to a grounding point through the first capacitor 94 and the first resistor 95 which are sequentially connected to each other in series.

For example, the power supply terminal on the high side 72PH is connected to a grounding point through the second capacitor 96 and the second resistor 97 which are sequentially connected to each other in series.

Both ends of the first resistor 95 are connected to the first normal mode output terminal on the high side 72NH and the first normal mode output terminal on the low side 72NL.

For example, the termination resistor changeover switch 98 and the changeover termination resistor 99 are connected between the first normal mode output terminal on the high side 72NH and the first normal mode output terminal on the low side 72NL in series.

The electronic measuring instrument 92 includes a measuring instrument such as a vector signal analyzer, a spectrum analyzer, or an oscilloscope which digitizes the size (level or the like) of noise inclusive of a time variation to measure a voltage or the like of noise (for example, normal mode noise on the high side) which is output from the first normal mode output terminal on the high side 72NH and the first normal mode output terminal on the low side 72NL.

For example, the electronic measuring instrument 92 includes a termination resistor 92R that connects the first normal mode output terminal on the high side 72NH and the first normal mode output terminal on the low side 72NL.

For example, in an opened state of the termination resistor changeover switch 98, the electronic measuring instrument 92 measures normal mode noise on the high side using a first termination resistance value (for example, 50Ω) based on a resistance value (for example, 50Ω) of the termination resistor 92R. On the other hand, in a closed state of the termination resistor changeover switch 98, the electronic measuring instrument measures normal mode noise on the high side using a second termination resistance value (for example, 25Ω) based on a combination of a resistance value (for example, 50Ω that is the same as the resistance value of the termination resistor 92R) of the changeover termination resistor 99 and the resistance value (for example, 50Ω) of the termination resistor 92R.

For example, similarly to the measurement of the common mode noise using the electronic measuring instrument 82, the electronic measuring instrument 92 estimates internal impedance of normal mode noise on the high side in the single electric and electronic component 60 on the basis of changes in measurement results according to a change in a termination resistance value which is associated with switching between opening and closing of the termination resistor changeover switch 98.

An output voltage of the normal mode noise on the high side in the single electric and electronic component 60 is estimated on the basis of the estimation results of the internal impedance.

For example, the electronic measuring instrument 92 acquires V(50Ω) and V(25Ω) which are measurement results of a voltage of the normal mode noise on the high side in the first termination resistance value (for example, 50Ω) and the second termination resistance value (for example, 25Ω), for example, as expressed by Expression (1) mentioned above, with respect to the normal mode noise on the high side of an appropriate output voltage V(x) having appropriate internal impedance Im(x) in the single electric and electronic component 60.

For example, the electronic measuring instrument 92 estimates internal impedance Im(25 Ω→50Ω) of the normal mode noise on the high side in the single electric and electronic component 60, for example, as expressed by Expression (2) mentioned above, on the basis of the amount of change ΔV according to the measurement results of the voltage of the normal mode noise on the high side changing to V(50Ω) and V(25Ω).

For example, as expressed by Expression (3) mentioned above, the electronic measuring instrument 92 estimates an output voltage P(50Ω) of the normal mode noise on the high side on the basis of internal impedance Im(25 Ω→50Ω) of the normal mode noise on the high side and the measurement result (for example, V(50Ω)) of the voltage of the normal mode noise on the high side in the first termination resistance value (for example, 50Ω).

The second normal mode noise detection unit 73 includes, for example, an artificial mains network 101 and an electronic measuring instrument 102.

The artificial mains network (Normal LISN) 101 includes, for example, a line impedance stabilization network (LISN), includes a normal mode input terminal on the low side 73L connected to the normal mode output terminal on the low side 71NL of the common mode noise detection unit 71, a power supply terminal on the low side 73PL connected to a negative electrode of the power supply 74, a second normal mode output terminal on the high side 73NH, and a second normal mode output terminal on the low side 73NL.

The artificial mains network 101 includes, for example, a winding 103, a first capacitor 104, a first resistor 105, a second capacitor 106, a second resistor 107, a termination resistor changeover switch 108, and a changeover termination resistor 109.

For example, the winding 103 is inserted into a connection line 73LL that connects the normal mode input terminal on the low side 73L and the power supply terminal on the low side 73PL.

For example, the normal mode input terminal on the low side 73L is connected to a grounding point through the first capacitor 104 and the first resistor 105 which are sequentially connected to each other in series.

For example, the power supply terminal on the low side 73PL is connected to a grounding point through the second capacitor 106 and the second resistor 107 which are sequentially connected to each other in series.

Both ends of the first resistor 105 are connected to the second normal mode output terminal on the high side 73NH and the second normal mode output terminal on the low side 73NL.

For example, the termination resistor changeover switch 108 and the changeover termination resistor 109 are connected between the second normal mode output terminal on the high side 73NH and the second normal mode output terminal on the low side 73NL in series.

The electronic measuring instrument 102 includes a measuring instrument such as a vector signal analyzer, a spectrum analyzer, or an oscilloscope which digitizes the size (level or the like) of noise inclusive of a time variation to measure a voltage or the like of noise (for example, normal mode noise on the low side) which is output from the second normal mode output terminal on the high side 73NH and the second normal mode output terminal on the low side 73NL.

For example, the electronic measuring instrument 102 includes a termination resistor 102R that connects the second normal mode output terminal on the high side 73NH and the second normal mode output terminal on the low side 73NL.

For example, in an opened state of the termination resistor changeover switch 108, the electronic measuring instrument 102 measures normal mode noise on the low side using a first termination resistance value (for example, 50Ω) based on a resistance value (for example, 50Ω) of the termination resistor 102R. On the other hand, in a closed state of the termination resistor changeover switch 108, the electronic measuring instrument measures normal mode noise on the low side using a second termination resistance value (for example, 25Ω) based on a combination of a resistance value (for example, 50Ω that is the same as the resistance value of the termination resistor 102R) of the changeover termination resistor 109 and the resistance value (for example, 50Ω) of the termination resistor 102R.

For example, similarly to the measurement of the normal mode noise on the high side using the electronic measuring instrument 92, the electronic measuring instrument 102 estimates internal impedance of normal mode noise on the low side in the single electric and electronic component 60 on the basis of changes in measurement results according to a change in a termination resistance value which is associated with switching between opening and closing of the termination resistor changeover switch 108.

An output voltage of the normal mode noise on the low side in the single electric and electronic component 60 is estimated on the basis of the estimation results of the internal impedance.

For example, the electronic measuring instrument 102 acquires V(50Ω) and V(25Ω) which are measurement results of a voltage of the normal mode noise on the low side in the first termination resistance value (for example, 50Ω) and the second termination resistance value (for example, 25Ω), for example, as expressed by Expression (1) mentioned above, with respect to the normal mode noise on the low side of an appropriate output voltage V(x) having appropriate internal impedance Im(x) in the single electric and electronic component 60.

For example, the electronic measuring instrument 102 estimates internal impedance Im(25 Ω→50Ω) of the normal mode noise on the low side in the single electric and electronic component 60, for example, as expressed by Expression (2) mentioned above, on the basis of the amount of change ΔV according to the measurement results of the voltage of the normal mode noise on the low side changing to V(50Ω) and V(25Ω).

For example, as expressed by Expression (3) mentioned above, the electronic measuring instrument 102 estimates an output voltage P(50Ω) of the normal mode noise on the low side on the basis of internal impedance Im(25 Ω→50Ω) of the normal mode noise on the low side and the measurement result (for example, V(50Ω)) of the voltage of the normal mode noise on the low side in the first termination resistance value (for example, 50Ω).

According to this embodiment, it is possible to appropriately attenuate common mode noise or normal mode noise of the electronic device 10. That is, according to the electromagnetic interference wave measuring device 70 of this embodiment, the first to third common mode choke coils 1A to 1C are provided, and thus a conductive interference wave generated from the single electric and electronic component 60 can be appropriately measured by separation into common mode noise and normal mode noise. Consequently, it is possible to estimate internal impedance of the common mode noise and the normal mode noise and a noise level (for example, output voltage) of a noise source with a high level of accuracy.

In addition, the technical scope of the invention is not limited to the above-described embodiment, and various changes may be made without departing from the scope of the invention.

The materials and shapes of the core 2, the winding member 3, the housing member 4, the spacer member 5, and the like in the embodiment are not limited to those in the embodiment.

Further, in the embodiment, the choke coil 1 may be provided in another electronic device other than the electromagnetic interference wave measuring device 70.

In the embodiment, although the housing member 4 is divided in an axial direction, the housing member may be divided in, for example, a radial direction. In addition, for example, the core 2 may be molded using a resin, and thus the housing member 4 may be formed without being divided.

Besides, it is possible to appropriately replace components in the above-described embodiment with well-known components without departing from the scope of the invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A choke coil comprising:
a core that is formed to have a ring shape; and
a winding member that is provided with an electrically conductive wire wound around the core,
wherein a housing member, interposed between the core and the winding member, is formed of a material having non-magnetic and non-conductive properties, has a ring shape corresponding to the core, and covers the core, and
wherein the housing member is formed in such a manner that a separation distance along a radial direction between an outer surface of the housing member and an outer surface of the core becomes uniform over a circumferential direction.

2. The choke coil according to claim 1,
wherein a plurality of guide units are formed on the outer surface of the housing member, and
wherein the guide units regulate the electrically conductive wire so that when the electrically conductive wire of the winding member is wound, the positions of the electrically conductive wires are located at regular intervals over the circumferential direction thereof.

3. The choke coil according to claim 1,
wherein a spacer member is provided coaxially with a central axis of the core within a center hole of the core,
wherein a plurality of groove portions extending along the axial direction and capable of disposing the electrically conductive wire are formed in an outer circumferential surface of the spacer member in response to the number of times of insertion of the electrically conductive wire into the center hole of the core, and
wherein the plurality of the groove portions are formed at regular intervals over the circumferential direction.

4. The choke coil according to claim 1,
wherein the housing member includes a supporting portion that extends toward the outside in the radial direction, and
wherein a base portion protruding so as to intersect an extension direction of the supporting portion is formed in a tip of the supporting portion.

5. The choke coil according to claim 1, wherein the core is formed in such a manner that a plurality of core members having different impedance frequency characteristics are laminated in the axial direction.

6. An electronic device that comprises the choke coil according to claim 1 to attenuate at least one noise of common mode noise and normal mode noise.
